(19) United States
(12) Patent Application Publication
(10) Pub. No.: US 2012/0226495 A1
(43) Pub. Date: Sep. 6, 2012

(54) DEVICE AND METHOD FOR FILTERING OUT NOISE FROM SPEECH OF CALLER

(75) Inventors: WEI WU, Shenzhen City (CN); XIN YANG, Shenzhen City (CN)

(73) Assignees: HON HAI PRECISION INDUSTRY CO., LTD., New Taipei (TW); FU TAI HUA INDUSTRY (SHENZHEN) CO., LTD., ShenZhen City (CN)

(21) Appl. No.: 13/241,273

(22) Filed: Sep. 23, 2011

(30) Foreign Application Priority Data
Mar. 3, 2011 (CN) 201110051320.6

(51) Int. Cl. G10L 21/02

(52) U.S. Cl. 704/205; 704/227; 704/E21.002

(57) ABSTRACT

A device and a method for filtering out noise from speech of caller are disclosed. The method is applied to the device, includes: inputting a speech sound of a caller; converting the speech sound to digital signals by an analyzing-to-digital converting unit; analyzing the digital signals to identify a pure speech of the caller and filtering out an extraneous noise thus obtaining pure speech signals of the caller; encoding the pure speech signals by a coder and decoder unit, and submitting the encoded speech signals to the receiver.

### BACKGROUND

1. Technical Field

The present disclosure relates to electronic devices and method applied thereto, more particularly relates to a device and a method for filtering out ambient noise from speech of a caller.

2. Description of Related Art

Nowadays, people use various electronic apparatuses including traditional telephones, mobile phones, and computers to make phone calls. However, there are problems in the communication process, one of which is the interference caused by background noise. If a speaker is calling from a noisy environment, the clarity of his/her voice will be reduced by unwanted sound, which obliges the speaker to increase his/her volume or cover up part of the microphone to block the noise. Moreover, under certain conditions, a caller may require privacy, needing to block all the background noise. Thus eliminating ambient noise while communicating by voice is an obvious requirement.

### BRIEF DESCRIPTION OF THE DRAWINGS

The components of the drawings are not necessarily drawn to scale, the emphasis instead being placed upon clearly illustrating the principles of the embodiments of the device and the method for filtering out noise from speech of caller. Moreover, in the drawings, like reference numerals designate corresponding parts throughout several views.

FIG. 1 is a block diagram illustrating the device for filtering out noise from speech of caller, according to an exemplary embodiment of the present disclosure.

FIG. 2 is a flowchart illustrating a process included of the method for filtering out noise from speech of caller, according to an exemplary embodiment of the present disclosure.

FIG. 3 is a flowchart illustrating the method for filtering out noise from speech of caller, according to an exemplary embodiment of the present disclosure.

### DETAILED DESCRIPTION

The device 100 for filtering out noise from speech of caller is applied to the electronic apparatus which provides the speaker with a multi-way-conversation capability to communicate with at least one receiver. Such electronic apparatus could be a mobile phone, a traditional phone, a PC (personal computer) or any other multimedia apparatus. Aforesaid multi-way-conversation can be a two-way-conversation or a three-way-conversation. The function provided from the device 100 is to help eliminating unwanted sound so as to increase the quality of spoken communication through the electronic apparatus.

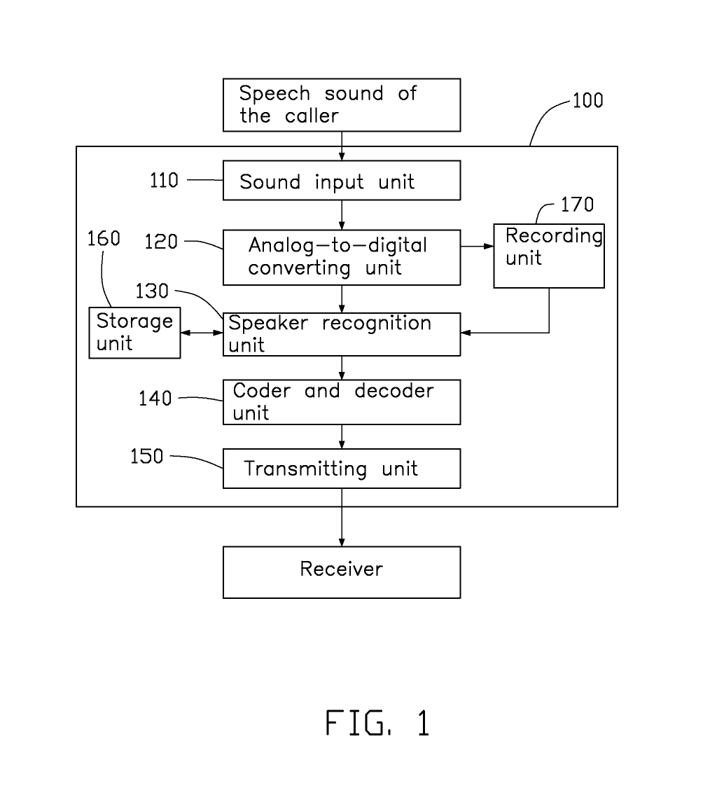

Referring to FIG. 1, which is a block diagram of the device according to an exemplary embodiment, the device 100 is composed of an sound input unit 110, an A/D (analog-to-digital) converting unit 120, a speaker recognition unit 130, a coder and decoder unit 140, a transmitting unit 150 and a storage unit 160. In this embodiment, the sound input unit 110 is a microphone, the analog-to-digital converting unit 120 is an A/D converter, and the transmitting unit 150 is a transceiver.

The storage unit 160 stores acoustic characteristics information respectively relating to a number of certain speakers. Each acoustic characteristics information is about one or more vocal characteristics identified with one of the speakers, and is established by several pro-storing steps which will describe later. The vocal characteristics mean some or all of the audio characteristics of every individual voice, including, but not limited to, the audio frequency, the natural volume and the timbre.

Acoustic characteristics information may be gathered by an external equipment, then transmitted to the device 100 and stored in the storage unit 160. Alternatively, the device 100 further has a recording unit 170, which may record the voice of the speaker in an undisturbed silent environment and submit it to the speaker recognition unit 130. The speaker recognition unit 130 may process the data into acoustic characteristics information.

The speaker recognition unit 130 is configured for analyzing the outputs from the analog-to-digital converting unit 120 to identify a pure speech of the caller, based on the acoustic characteristics information stored in the storage unit 160. And then it filters out an extraneous noise to obtain pure speech signals of the caller and transmit them to the coder and decoder unit 140. The pure speech signals are encoded by the coder and decoder unit 140, and submitted to the receiver through the transmitting unit 150.

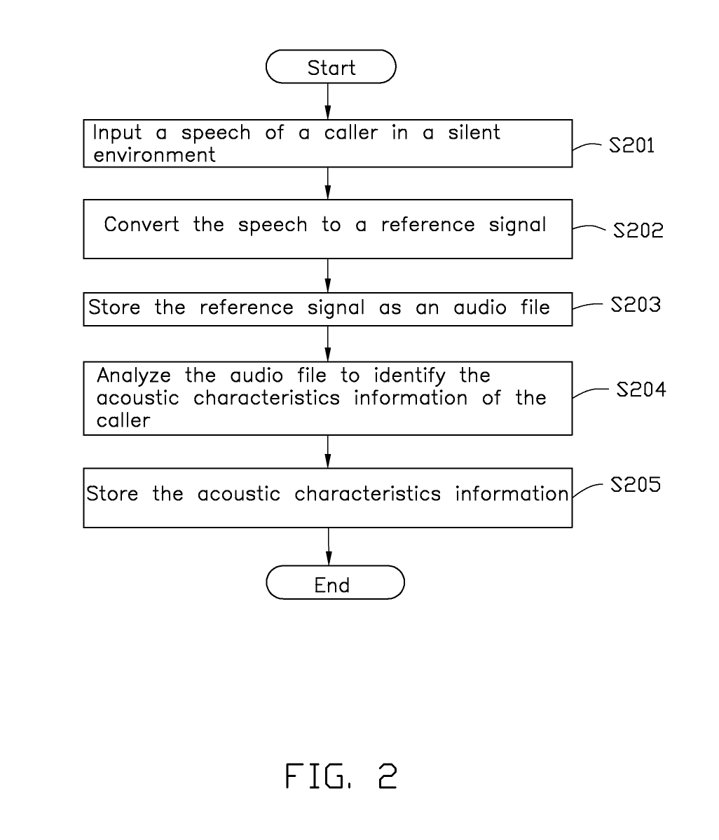

In this embodiment, the method includes a previous process taken for detecting the acoustic characteristics of a particular speaker and storing the acoustic characteristics information thereof. Referring to FIG. 2, which shows a flowchart illustrating the process included of the method, the process comprises: inputting a speech of a caller in a silent environment through the sound input unit 110 (S201); converting the speech of the caller to a reference signal by the analog-to-digital converting unit 120 (S202); the recording unit 170 producing an audio file according to the reference signal, and storing the audio file in the storage unit 160 (S203); the speaker recognition unit 130 analyzing the audio file, identifying the acoustic characteristics of the caller and accordingly producing the acoustic characteristics information (S204); the speaker recognition unit 130 storing the acoustic characteristics information to the storage unit 160 (S205).

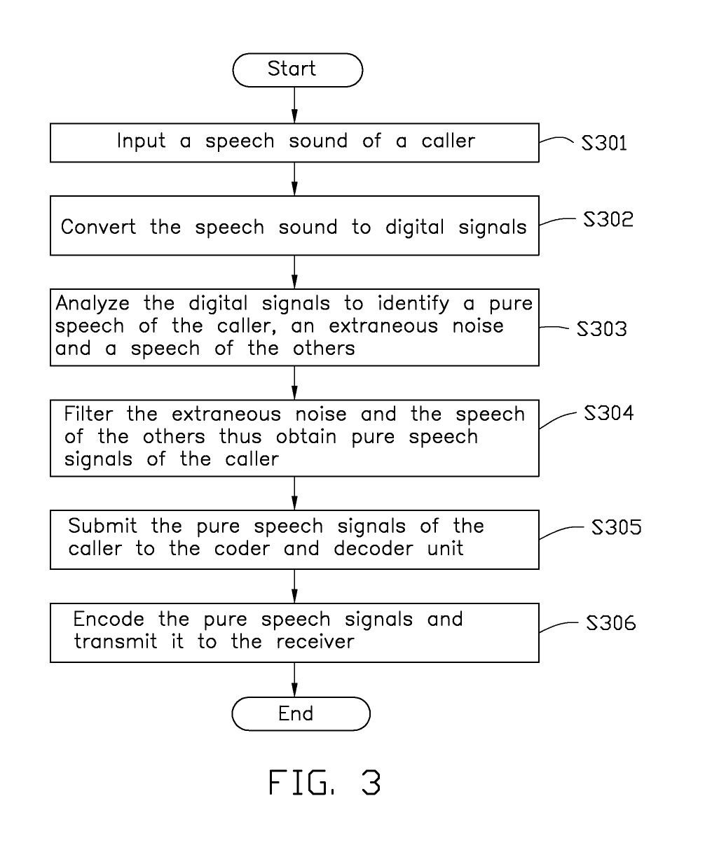

Referring to FIG. 3, which shows a flowchart illustrating the method for filtering out noise from speech of caller in the exemplary embodiment, the method includes the following steps: inputting a speech sound of a caller through the sound input unit 110 (S301); the analog-to-digital converting unit 120 converting the speech sound to digital signals (S302); the speaker recognition unit 130 analyzing the digital signals, identifying a pure speech of the caller. Moreover, identifying an extraneous noise and a speech of the others (S303).

Then, filtering out the extraneous noise and the speech of the others (S304); the speaker recognition unit 130 submitting the pure speech signals of the caller to the coder and decoder unit 140 (S305); the coder and decoder unit 140 encoding the pure speech signals of the caller and submitting the encoded signals to the receiver (S306).

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A communication device comprising:
a storage unit configured for storing acoustic characteristics information of a caller;
a sound input unit configured for inputting speech sound of the caller;
an analog-to-digital converting unit configured for converting the speech sound into digital signals;
a speaker recognition unit configured for analyzing the digital signals based on the acoustic characteristics information to identify a pure speech of the caller, and filter out an extraneous noise, thus obtaining pure speech signals of the caller;
a coder and decoder unit configured for encoding the pure speech signals; and
a transmitting unit configured for transmitting the encoded speech signals to a receiver.

2. The communication device according to claim 1, wherein the acoustic characteristics information is selected from the group consisting of the audio frequency of the caller, the natural volume of the caller, the individual timbre of the caller, and any combination thereof.

3. The communication device according to claim 1, wherein the sound input unit is a microphone.

4. The communication device according to claim 1, wherein the storage unit stores a plurality of acoustic characteristics information respectively associated with different callers.

5. A communication method comprising:
(a) inputting a speech sound of a caller;
(b) converting the speech sound to digital signals;
(c) analyzing the digital signals to identify a pure speech of the caller;
(d) filtering out an extraneous noise, thus obtaining pure speech signals of the caller; and
(e) encoding the pure speech signals and transmitting the encoded speech signals to a receiver.

6. The communication method according to claim 5, wherein the pure speech is identified by comparing the digital signals with an acoustic characteristics information of the caller.

7. The communication method according to claim 6, wherein the acoustic characteristics information of the caller is stored in a storage unit using a process comprising:
inputting a speech of the caller in a silent environment;
converting the speech of the caller into a reference signal;
analyzing the reference signal to obtain the acoustic characteristics information of the caller; and
storing the acoustic characteristics information in the storage unit

8. The communication method according to claim 7, wherein the voice characteristics information is selected from the group consisting of the audio frequency of the caller, the natural volume of the caller, the individual timbre of the caller and any combination thereof.
